(19) United States
(12) Patent Application Publication
(10) Pub. No.: US 2012/0311008 A1
(43) Pub. Date: Dec. 6, 2012

(54) SMART ROUNDING SUPPORTING PSYCHOLOGICAL PRICING

(75) Inventor: Jakob Hall, Hillerod (DK)

(73) Assignee: MICROSOFT CORPORATION, Redmond, WA (US)

(21) Appl. No.: 13/151,120

(22) Filed: Jun. 1, 2011

(51) Int. Cl. G06F 7/38

(52) U.S. Cl. 708/551

(57) ABSTRACT

Pricing values may be automatically computed by converting a base price with a predefined price ending based on predetermined rounding rules. A base price may be adjusted employing a rounding syntax and two pricing points, one for a rounding lower limit the other for rounding upper limit. Based on a comparison of a portion of the price computed with the rounding syntax, the adjusted (or sales) price may be computed reflecting a desired pricing strategy such as a psychological pricing strategy.

### BACKGROUND

Psychological pricing or price ending is a marketing practice based on the assumption that certain prices have a psychological impact. The retail prices are often expressed as odd prices, a little less than a round number such as $19.99 or $9.95. Some studies suggest the slightly lower fractional pricing may drive demand greater than would be expected. The psychological pricing theory is based on the assumptions that consumers are likely to ignore the least significant digits rather than do the proper rounding (even if subconsciously); fractional prices suggest to consumers that items are marked at the lowest possible price; and a behavioral phenomenon referred to as the left-digit anchoring effect suggesting that judgments of numerical differences are anchored on left-most digits (e.g., people perceive the difference between 1.99 and 3.00 to be closer to 2.01 than to 1.00 because their judgments are anchored on the left-most digit).

A base sales price for an item can be calculated in many ways. It may be a result of the item's bill of material, calculated based on a purchase price or it could be exchanged from one sales price in one currency to another. The result for any such calculation of base prices may be an unintended price ending incompatible with psychological (or other formats) of pricing. Conventional methods employ manual control for price ending calculations, which may be cumbersome or even impractical in a large market environment where goods and services may be high in numbers and offered in various countries/regions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatic determination of pricing values by converting a base price with a predefined price ending based on predetermined rounding rules. According to some embodiments, a base price may be adjusted employing a rounding syntax and two pricing points, one for a rounding lower limit the other for rounding upper limit. Based on a comparison of a portion of the price computed with the rounding syntax, the adjusted (or sales) price may be computed reflecting a desired pricing strategy such as a psychological pricing strategy.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where smart rounding based on rounding rule(s) and a rounding syntax may be implemented according to some embodiments;

FIG. 2 illustrates example smart rounding calculations;

FIG. 3 illustrates conceptually computation of adjusted pricing from a base price employing rounding rules;

FIG. 4 illustrates a screenshot of an example user interface for a business application employing smart rounding;

FIG. 5 is a networked environment, where a system according to embodiments may be implemented;

FIG. 6 is a block diagram of an example computing operating environment, where embodiments may be implemented;

FIG. 7 illustrates a logic flow diagram for a process of performing smart rounding according to embodiments;

FIG. 8 illustrates a logic flow diagram for a process of rounding down based on a point for rounding to lower limit; and

FIG. 9 illustrates a logic flow diagram for a process of rounding up based on a point for rounding to upper limit.

### DETAILED DESCRIPTION

As briefly described above, pricing values may be automatically calculated by an application through converting a base price with a predefined price ending based on predetermined rounding rules. A base price may be adjusted employing a rounding syntax and two pricing points, one for a rounding lower limit the other for rounding upper limit.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing business services with smart rounding for prices. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

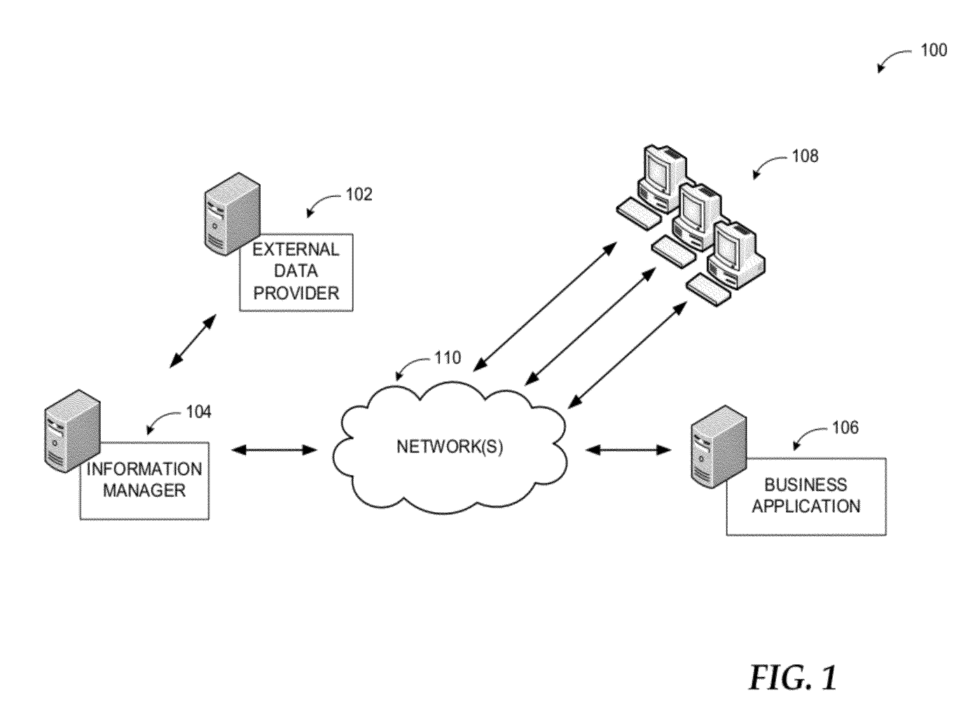

Referring to FIG. 1, diagram 100 illustrates a networked environment, where smart rounding based on rounding rule(s) and a rounding syntax may be implemented according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a server may host a business application 106. The business application 106 may be, for example, a customer resource management (CRM) application. The business application 106 may enable users accessing the application through client devices 108 over network(s) 110 to perform business operations including defining pricing strategies, determining adjusted prices, etc. For example, base prices for certain goods or services in an enterprise may be determined in one geographic region or country and the goods or services offered in other regions.

Business application 106 receiving base price, pricing strategy, rounding rules, and similar information from an information manager 104 (e.g., another server/application/data store within the CRM service) may compute adjusted prices for the goods and services in a particular region and provide those to a user. Alternatively, some or all of the information may be received from external data provider(s) 102. Embodiments are not limited to client/server architectures and may be deployed using other architectures such as peer-to-peer, etc.

Smart rounding reduces or eliminates the manual interaction with the base price to make it obey the desired price ending, making the maintenance of sales prices more flexible and agile to any changes to the variables for the base price calculation. For example, the base sales price for an item may be calculated based on purchase prices of its raw materials. A change to the purchase price for one raw material may impact the base sales price. Smart rounding may ensure that the final sales price will obey the desired price ending without a need for manual interaction.

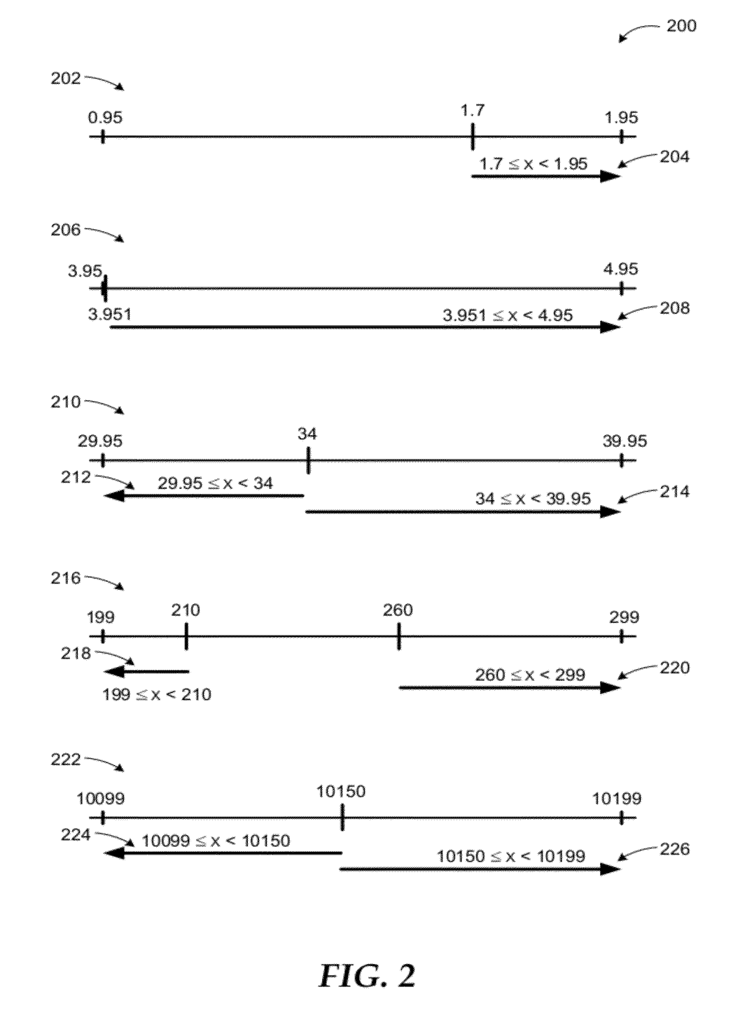

FIG. 2 illustrates example smart rounding calculations. A system according to embodiments determines pricing values by converting a base price with a predefined price ending based on predetermined rounding rules. The rounding rules may include a lower limit for the rule, an upper limit for the rule, a rounding syntax, a point for rounding to lower limit, and a point for rounding to upper limit. The lower limit for the rule and the upper limit for the rule indicate a price range, where the rounding rule is valid. Either of the lower limit for the rule and the upper limit for the rule may be defined as inclusive (but not both). In some embodiments, the lower limit for the rule may be inclusive and the upper limit for the rule exclusive. The upper limit for the rule may be smaller or equal the lower limit for the rule for the rounding rules relevant for the new price range for larger sales prices. “#” is used herein as the variable part of the result after applying rounding. The “#” may be placed equally for the rounding syntax, point for rounding to lower limit and point for rounding to upper limit.

Common rounding rules, where rounding is to the nearest integer can be expressed as:

If A≦X<A+0.5 then Round(X)=A, and [1]

If A+0.5≦X≦A+1 then Round(X)=A+1, where A is an integer. [2]

In other words, if the value is less than A+0.5 then it should be rounded to the nearest lower limit. If the value is bigger or equal A+0.5 then it should be rounded to the nearest upper limit. In terms of the parameters described above, the rounding syntax (“#”) indicates that the result should be an integer; the point for rounding to lower limit indicates that numbers where the digit after the integer is less than 5 should be rounded to the previous number with the given syntax (“#0.5”); and the point for rounding to upper limit indicates that numbers where the digit after the integer is bigger or equal 5 should be rounded to the next number with the given syntax (“#0.5”).

Instead of rounding to the nearest integer, the number may be rounded to a different value such as “#0.95”. This may be performed by:

If A−0.05≦X<A+0.45 then Round(X)=A−0.05, and [3]

If A+0.45≦X<A+0.95 then Round(X)=A+0.95. [4]

Thus, if the value is less than A+0.45 and greater than A−0.05 then it should be rounded to the nearest lower limit (A−0.05), and if the value is bigger or equal A+0.45 and less than A+0.95 then it should be rounded to the nearest upper limit (A+0.95). Hence, the number is rounded to the nearest number with the syntax “#0.95” with an axis shift in rounding process. The shifting is scalable and can be extended to other syntaxes.

A number of situations may exist, where there is a need for non-symmetric rounding (narrow the range for rounding down sustains more margin, and narrow the range for rounding up might be proper in a very price competitive market, for example). Non-symmetric rounding may be performed as only rounding up within an extended interval or no rounding in an interval between an upper and a lower limit. Both approaches are also scalable and can be extended to other syntax forms.

Diagram 200 illustrates a variety of smart rounding approaches. For example, approach 202 shows rounding with only a point for rounding to upper limit defined. Thus, in the example range between 0.95 and 1.95, any value above the point for rounding to upper limit 1.7 may be rounded to 1.95 (204). The rounding syntax in approach 202 is #0.95. Approach 206 shows an example of the point for rounding to upper limit being selected close to the lower limit of the range. In the example range of 3.95 to 4.95, the point for rounding to upper limit is selected at 3.951. Thus, any value above or equal to the point for rounding to upper limit 3.951 may be rounded to 4.95 (208). The rounding syntax in approach 206 is also #0.95.

In example approach 210, the point for rounding to lower limit and the point for rounding to upper limit are the same (“34”). The limit points are, however, not selected symmetrically within the range 29.95 to 39.95. Thus, any value between 29.95 and 34 (exclusive) is rounded down to 29.95 (212), while any value between 34 (inclusive) and 39.95 is rounded up to 39.95 (214). The rounding syntax in approach 210 is #9.95.

In example approach 216, two distinct limit points are used. The point for rounding to lower limit is at 210 (exclusive), while the point for rounding to upper limit is at 260 (inclusive) within an example range of 199 to 299. Thus, any values between 199 and 210 are rounded down to 199 (218), while any values between 260 and 299 are rounded up to 299 (220) leaving the values between 210 and 260 un-rounded. The rounding syntax for this scenario is “#99”.

Approach 222 illustrates a scenario, where the points for rounding to lower limit and to upper limit are at the same value (“10150”), which is at approximately the center of the range between 10099 and 10199. Thus, values between 10099 and 10150 are rounded down to 10099 (224), while values between 10150 and 10199 are rounded up to 10199 (226). The rounding syntax for this scenario is also “#99”.

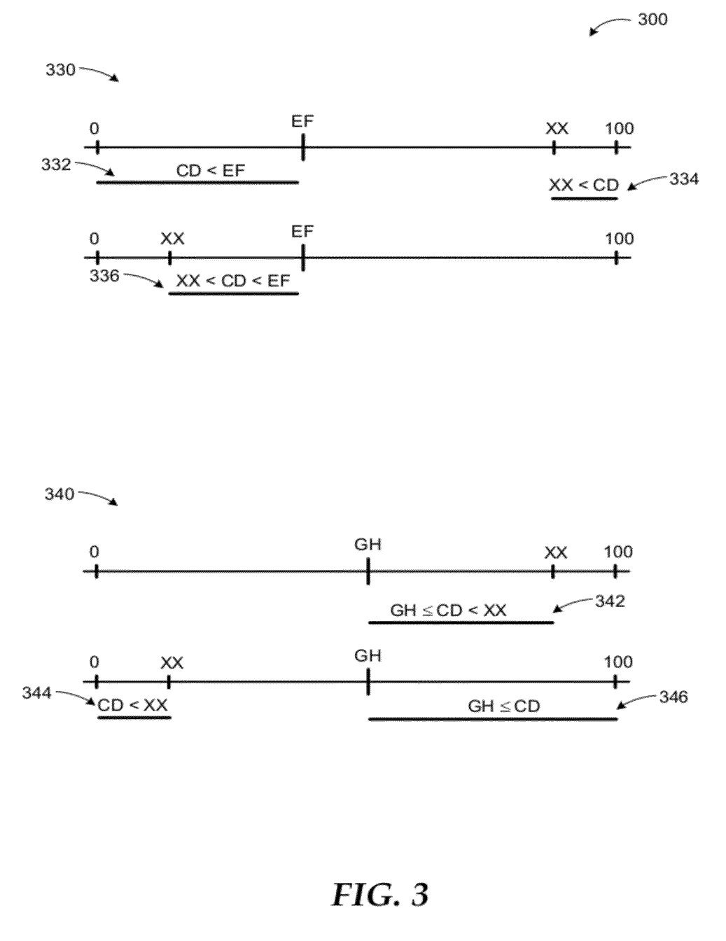

FIG. 3 illustrates conceptually computation of adjusted pricing from a base price employing rounding rules. Diagram 300 illustrates when a price can be rounded down or rounded up based on comparison with the points for rounding to upper and lower limits.

The base price may be represented by the number “ABCD”, which according to the example rounding rule for the point for rounding to lower limit is to be rounded to “#XX”. “#XX” and “#EF” are shown on the range of values 330 in diagram 300. First, digits corresponding to “#” (in the example case “AB”) may be removed leaving “CD”. In the first scenario, “XX” is greater than “EF”. In that case, “ABCD” may be rounded down to “ABXX-100” if “CD”<“EF” (332) or to “ABXX” if “XX”<“CD” (334). In the second scenario “XX” may be smaller than “EF”. In that case, “ABCD” may be rounded down to “ABXX” if “XX”<“CD”<“EF” (336).

If the base price “ABCD” is not to be rounded down (as determined by the above computation), it may be rounded up according to a comparison with the point for rounding to upper limit “GH” as shown over the range of values 340. “XX” is greater than “GH” in the first scenario. In that case, “ABCD” may be rounded up to “ABXX” if “GH”≦“CD”<“XX (342). According to the second scenario, where “XX” is smaller than “GH”, “ABCD” may be rounded up to “ABXX” if “CD”<“XX” (344) or to “ABXX+100” if “GH”≦“CD” (346).

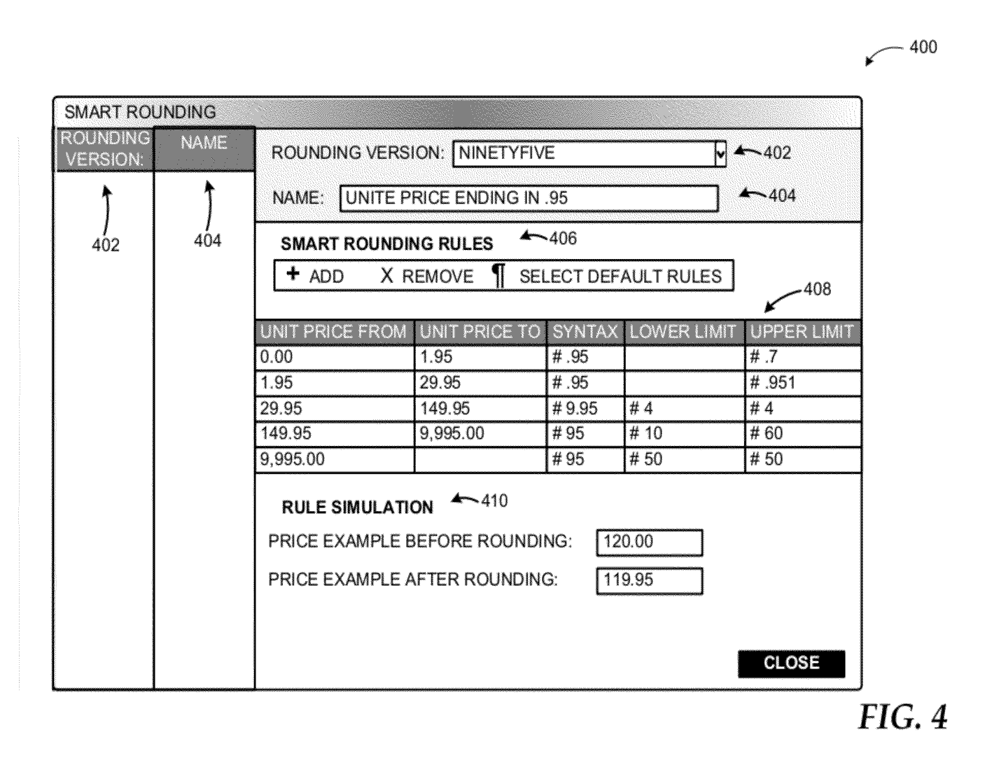

FIG. 4 illustrates a screenshot of an example user interface for a business application employing smart rounding. Smart rounding may be performed by any application, locally installed or hosted, that processes pricing. The computations may be integrated into a larger process of price determination or performed by a separate module based on input data. A user interface such as the example user interface 400 of FIG. 4 may enable users to configure parameters, define rounding rules, view results, etc.

Example user interface 400 may include a listing of available rounding versions and their names (402, 404) on one portion to allow a user to select among the available rounding versions. Users may also be enabled to specify (e.g., through a text box entry) or select from a drop-down menu a rounding version for the smart rounding computation. Rounding rules 406 may be added, removed, modified, or selected among default ones through example user interface 400. The list 408 includes available rounding rules with original sales price (“Unit Price From”), which is a lower limit for the rounding rule; adjusted sales price (“Unit Price To”), which is an upper limit for the rounding rule; and rounding syntax. Upon selection or entry of a new rounding rule, a rule simulation 410 may be displayed showing an example price adjustment based on the selected/defined rule.

The example systems, computations, and user interfaces in FIG. 1 through 4 are shown with specific components, data types, and configurations. Embodiments are not limited to systems according to these example configurations. Smart rounding supporting psychological pricing may be implemented in configurations employing fewer or additional components in applications and user interfaces using the principles described herein.

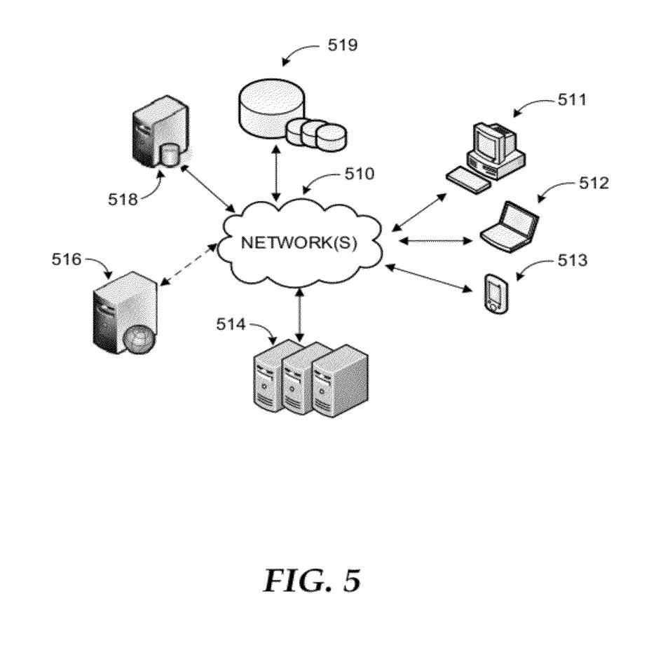

FIG. 5 is a networked environment, where a system according to embodiments may be implemented. Business applications such as a CRM application executed over one or more servers 514 or a single server (e.g. web server) 516 such as a hosted service may employ smart rounding in computing pricing for goods and services in various regions or for changing conditions (e.g., changing exchange rates, base prices, etc.). The business application(s) may communicate with client applications on individual computing devices such as a smart phone 513, a laptop computer 512, or desktop computer 511 ('client devices') through network(s) 510.

As discussed above, the business applications may automatically determine pricing values by converting a base price with a predefined price ending based on predetermined rounding rules. The base price may be adjusted employing a rounding syntax and two pricing points, one for a rounding lower limit the other for rounding upper limit. Based on a comparison of a portion of the price computed with the rounding syntax, the adjusted (or sales) price may be computed reflecting a desired pricing strategy such as a psychological pricing strategy.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to compute adjusted pricing based on smart rounding approach. Furthermore, the networked environments discussed in FIG. 5 are for illustration purposes only. Embodiments are not limited to the example applications, modules, or processes.

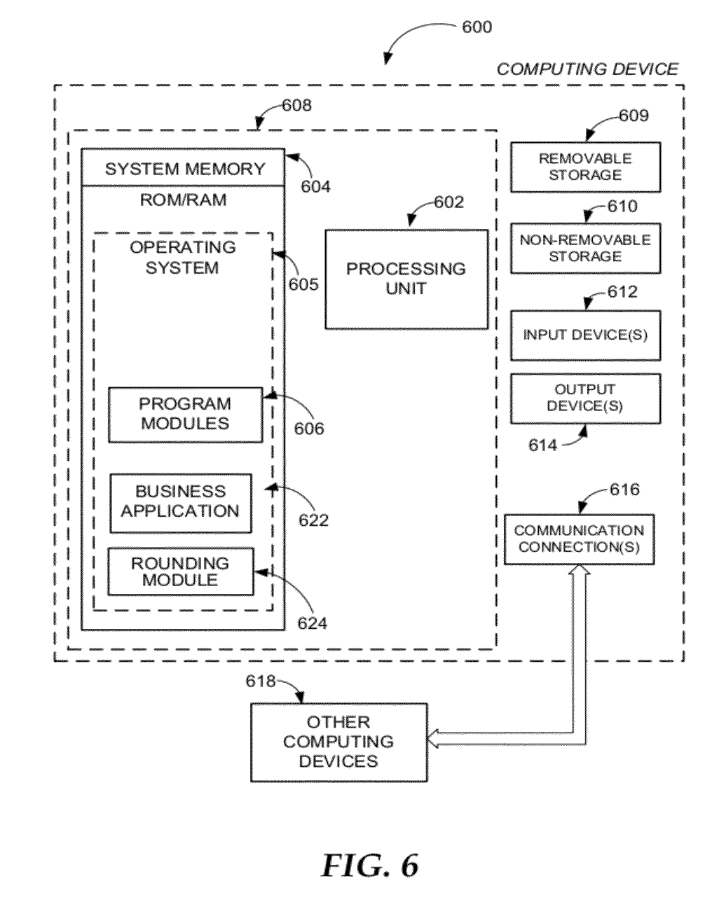

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Washington. The system memory 604 may also include one or more software applications such as program modules 606, business application 622, and rounding module 624.

Business application 622 may be a CRM application determining adjusted prices among other things. The rounding module 624 may automatically compute adjusted prices based on predefined rounding rules and syntaxes as described previously. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

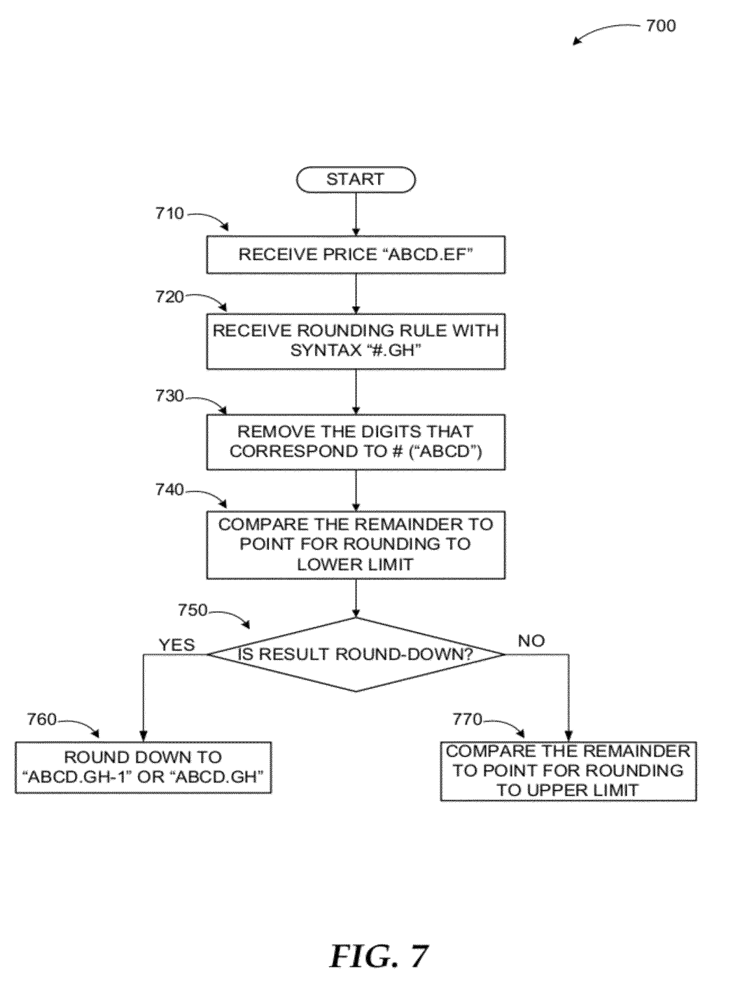

FIG. 7 illustrates a logic flow diagram for process 700 of performing dynamic rounding according to embodiments. Process 700 may be implemented by a business application such as a CRM application on any computing device.

Process 700 begins with operation 710, where a base price is received in an example format “ABCD.EF”. At operation 720, a rounding rule may be received according to which the base price is to be rounded to the syntax “#.GH”. At operation 730, the digits corresponding to “#” may be removed from the base price value (in the example price “ABCD”).

At operation 740, the remainder of the value (“EF”) may be compared to a point for rounding to lower limit and/or to a point for rounding to upper limit. If the result of the comparison is determined to be a round-down at decision operation 750, the base price may be rounded down (e.g., in the form “ABCD.GH−1” or “ABCD.GH) at operation 760. Otherwise, the base price may be rounded up (e.g., in the form “ABCD.GH+1” or “ABCD.GH”) at operation 770.

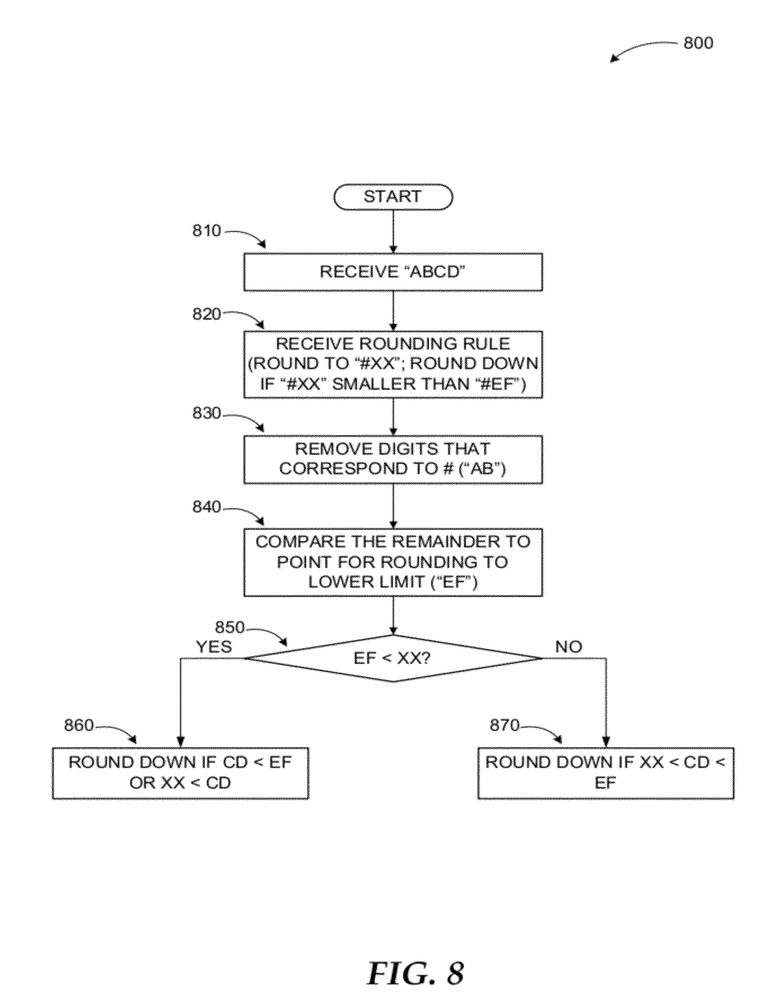

FIG. 8 illustrates a logic flow diagram for a process of rounding down based on a point for rounding to lower limit. Process 800 is a detailed description of the sub-process of determining a round-down based on comparison to the point for rounding to lower limit as discussed at operation 740 above.

At operation 810, the number “ABCD” is received, which according to the rounding rule received at operation 820 is to be rounded to “#XX” format and is to be rounded down if “#XX” with lower limit equal to “#EF”. At operation 830, digits corresponding to “#” (in the example case “AB”) are removed leaving “CD”. At operation 840, the remainder “CD” is compared to the point for rounding to lower limit (“EF”).

If “EF” is determined to be less than “XX” at decision operation 850, “ABCD” is rounded down at operation 860 under the conditions “CD” <“EF” or “XX”<“CD”. On the other hand, if “XX” is determined to be less than EF at decision operation 850, “ABCD” is rounded down at operation 870 under the condition “XX”<“CD”<“EF”.

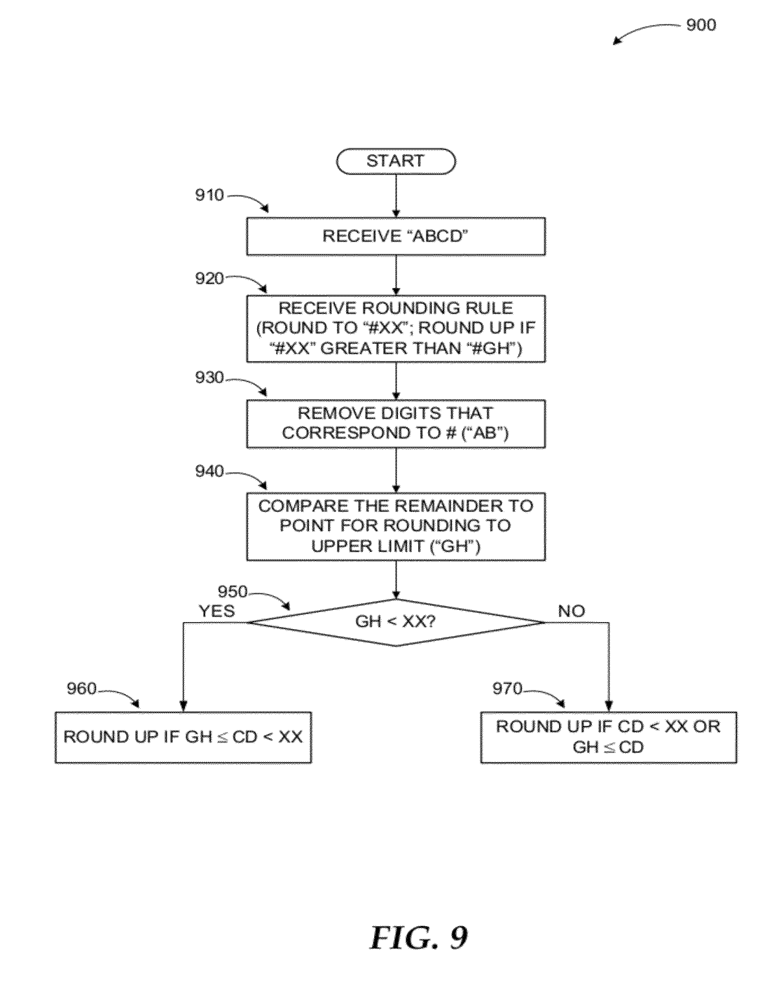

FIG. 9 illustrates a logic flow diagram for a process of rounding up based on a point for rounding to upper limit. Process 900 is a detailed description of the sub-process of determining a round-up based on comparison to the point for rounding to upper limit as discussed at operation 740 above.

At operation 910, the number “ABCD” is received, which according to the rounding rule received at operation 920 is to be rounded to “#XX” format and is to be rounded up if “#XX” is greater than the upper limit “#GH”. At operation 930, digits corresponding to “#” (in the example case “AB”) are removed leaving “CD”. At operation 940, the remainder “CD” is compared to the point for rounding to upper limit (“GH”).

If “GH” is determined to be less than “XX” at decision operation 950, “ABCD” is rounded up at operation 960 under the condition “GH”≦“CD”<“XX”. On the other hand, if “XX” is determined to be less than “GH” at decision operation 950, “ABCD” is rounded up at operation 970 under the conditions “CD”<“XX” or “GH”≦“CD”.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in processes 700, 800, and 900 are for illustration purposes. Smart rounding with support for psychological pricing may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for adjusting a base price based on dynamic rounding, the method comprising:
receiving the base price;
receiving rounding rule and rounding syntax;
removing digits corresponding to a generic portion of the base price according to the rounding syntax;
determining if the base price is to be rounded down based on a comparison of a remaining portion of the base price to a point for rounding down to a previous valid price fulfilling the rounding syntax defined by the rounding rule; and
if the determination is round-down, rounding the base price down to the previous valid price fulfilling the rounding syntax.

2. The method of claim 1, further comprising:
determining if the base price is to be rounded up based on a comparison of the remaining portion of the base price to a point for rounding up to next valid price fulfilling the rounding syntax defined by the rounding rule; and
if the determination is round-up, rounding the base price up to the next valid price fulfilling the rounding syntax.

3. The method of claim 1, wherein the rounding rule includes the base price, an adjusted sales price, the rounding syntax, the point for rounding to lower limit, and the point for rounding to upper limit.

4. The method of claim 3, wherein the base price and the adjusted sales price define a price range within which the rounding rule is valid.

5. The method of claim 3, wherein either one of the base price and the adjusted sales price are defined as inclusive, but not both.

6. The method of claim 1, further comprising:
narrowing a range for rounding down the base price to sustain more margin in an adjusted sales price.

7. The method of claim 1, further comprising:
narrowing a range for rounding up the base price to increase competitiveness in a price competitive market.

8. The method of claim 1, wherein a range for rounding the base price includes at least one region where the base price is not modified.

9. The method of claim 1, wherein the rounding rule includes one of: rounding the base price up to a next valid price fulfilling the rounding syntax only and rounding the base price down to the previous valid price fulfilling the rounding syntax only.

10. The method of claim 1, wherein a range for rounding the base price, the point for rounding to lower limit, and a point for rounding to upper limit are scalable such that the rounding is extensible to other syntax forms.

11. A computing device for adjusting a base price based on dynamic rounding, the computing device comprising:
a memory storing instructions; and
a processor coupled to the memory, the processor executing a business application in conjunction with the instructions stored in the memory, wherein the business application is adapted to:
receive the base price;
receive rounding rule and a rounding syntax;
remove digits corresponding to a generic portion of the base price according to the rounding syntax;
determine if the base price is to be rounded down based on a comparison of a remaining portion of the base price to a point for rounding down to a previous valid price fulfilling the rounding syntax defined by the rounding rule;
if the determination is round-down, round the base price down to the previous valid price fulfilling the rounding syntax; else
determine if the base price is to be rounded up based on a comparison of the remaining portion of the base price to a point for rounding up to a next valid price fulfilling the rounding syntax defined by the rounding rule; and
if the determination is round-up, round the base price up to the next valid price fulfilling the rounding syntax.

12. The computing device of claim 11, wherein a range for rounding the base price includes at least one region where the base price is not modified, at least one other region where the base price is rounded down, or at least one further region where the base price is rounded up.

13. The computing device of claim 11, wherein the business application is adapted to one of:
round the base price up only and round the base price down only.

14. The computing device of claim 13, wherein the business application is further adapted to compute an adjusted sales price based on one of rounding up and rounding down for at least one geographic region that is different from a geographic region generating the base price.

15. The computing device of claim 11, wherein the business application is adapted to perform rounding computations as a distinct module within a business service.

16. The computing device of claim 11, wherein the business application is provided as one of a locally installed application and a hosted service.

17. A computer-readable memory device with instructions stored thereon for adjusting a base price based on dynamic rounding, the instructions comprising:
receiving the base price;
receiving rounding rule that includes the base price, an adjusted sales price, a rounding syntax, a point for rounding to lower limit, and a point for rounding to upper limit;
removing digits corresponding to a generic portion of the base price according to the rounding syntax;
determining if the base price is to be rounded down based on a comparison of a remaining portion of the base price to the point for rounding down to a previous valid price fulfilling the rounding syntax defined by the rounding rule;
if the determination is round-down, rounding the base price down to the previous valid price fulfilling the rounding syntax; else
determining if the base price is to be rounded up based on a comparison of the remaining portion of the base price to the point for rounding up to a next valid price fulfilling the rounding syntax defined by the rounding rule; and
if the determination is round-up, rounding the base price up to the next valid price fulfilling the rounding syntax.

18. The computer-readable memory device of claim 17, wherein the instructions further comprise:
providing a user interface that enables a user to at least one of: specify a rounding version and select among a plurality of rounding versions to be applied to the base price.

19. The computer-readable memory device of claim 18, wherein the instructions further comprise:
enabling the user to at least one of: add, remove, modify, and select one or more rounding rules, wherein each rounding version is based on at least one rounding rule.

20. The computer-readable memory device of claim 17, wherein the instructions further comprise:
upon one of a selection of an existing and an entry of a new rounding rule, displaying a rule simulation of an example price adjustment on the user interface.
